(19) United States
(12) Patent Application Publication
(10) Pub. No.: US 2024/0413572 A1
(43) Pub. Date: Dec. 12, 2024

(54) ASSEMBLY FOR LOCKING TWO PARTS BY A BAYONET SYSTEM, AND CORRESPONDING METHOD

(71) Applicant: D&I Investment, LE CHESNAY ROCQUENCOURT (FR)

(72) Inventor: Razvan Stephane ILIE, ROQUENCOURT (FR)

(21) Appl. No.: 18/737,781

(22) Filed: Jun. 7, 2024

(30) Foreign Application Priority Data
Jun. 12, 2023 (FR) 2305909

(51) Int. Cl. H01R 13/625; F16B 7/20

(52) U.S. Cl. CPC H01R 13/625; F16B 7/20

(57) ABSTRACT

An assembly comprising a first part (12) and a second part (14) movable according to a connection axis (D) between a locked configuration and an unlocked configuration. The first part comprises one of a rail (42) and a groove, and the second part comprises the other. A ring (16) is rotatably mounted on the first part and forms a locking ramp and a housing. The second part defines a radially inner surface delimiting a housing (66) able to receive at least part of the ring and includes at least one pin (46) projecting into the housing. The first part comprises a return system of the ring. The locking ramp and the housing are configured so that manual axial displacement (D1) of the first part and the second part toward each other causes the sliding of the pin on the locking ramp, and an automatic angular displacement of the ring in a first direction and then in a second opposite direction, the pin being received and blocked axially in the housing.

### BACKGROUND OF THE DISCLOSURE

### Field of the Disclosure

The present invention relates to an assembly comprising a first part and a second part which are movable relative to each other between a locked configuration, in which the first part and the second part are partially fitted into each other and locked to each other, and an unlocked configuration, in which the first part and the second part are spaced apart from each other.

The invention also relates to a corresponding locking/unlocking method.

### Description of Related Art

Such an assembly is used, for example, to connect and disconnect two electric cables.

Existing bayonet assemblies are robust, but their ergonomics are questionable. Indeed, the fact of having to perform a movement in rotation to ensure locking of the two parts together is sometimes considered tedious by a user.

One aim of the invention is therefore to provide an assembly as described above that allows locking that is as robust as bayonet assemblies, while presenting improved ergonomics.

### BRIEF SUMMARY OF THE DISCLOSURE

To this end, an object of the invention is an assembly comprising a first part and a second part which are movable in translation relative to each other according to a connection axis between a locked configuration, in which the first part and the second part are partially fitted into each other and locked to each other, and an unlocked configuration, in which the first part and the second part are spaced apart from each other, characterized in that:
the first part comprises one of a rail and a groove, and the second part comprises the other of a rail and a groove, the rail being configured to slide axially in the groove as the first part and the second part move from the unlocked configuration to the locked configuration,
the assembly comprises a ring rotatably mounted on the first part about the connection axis, the ring comprising a wall extending about the connection axis and forming a locking ramp and a housing,
the second part defines a radially inner surface relative to the connection axis, said radially inner surface delimiting a housing able to receive at least the wall of the ring in the locked configuration, the second part comprising at least one pin projecting into the housing from the radially inner surface,
the first part comprises a return system able to exert a return force on the ring toward a rest position of the ring, and
the locking ramp and the housing are configured so that a manual axial displacement of the first part and the second part, one relative to the other from the unlocked configuration to an intermediate configuration causes a first sliding of the pin on the locking ramp, and an automatic angular displacement of the ring in a first direction relative to the first part between the rest position and an intermediate position, and so that manual axial displacement of the first part and the second part relative to each other from the intermediate configuration to the locked configuration allows automatic angular displacement of the ring relative to the first part in a second direction, opposite to the first direction, from the intermediate position to a locked position under the action of the return system, the pin being received in the housing when the ring is in the locked position, the housing defining an axial stop able to block the pin axially relative to the first part.

According to particular embodiments, the assembly comprises one or more of the following features, taken alone or according to any technically possible combination:
the first part comprises at least one first electrical contact, and a first electrical insulation sleeve surrounding the first electrical contact about the connection axis; and the second part comprises at least one second electrical contact, and a second electrical insulation sleeve surrounding the second electrical contact about the connection axis, the first electrical contact being in electrical contact with the second electrical contact in the locked configuration, and spaced apart from the second electrical contact in the unlocked configuration;
the wall of the ring forms a release ramp able to manually displace the ring in rotation about the connection axis in the first direction relative to the first part from the locked position, removes the pin from the first housing and causes a second sliding of the pin on the release ramp, the release ramp exerting an axial force on the pin to move the first part and the second part axially away from each other from the locked configuration;
the release ramp is curved, the release ramp forming an angle with the connection axis which reduces with increasing distance away from the housing;
the release ramp comprises a proximal portion relative to the housing, the proximal portion forming an angle of less than 40°, preferably 20°, with any plane perpendicular to the connection axis;
the second part comprises a spring located in the housing and able to exert an axial force on the first part in the locked configuration, the axial force being directed from the second part toward the first part;
the wall defines a notch opening axially from the side of the second part, the locking ramp and the housing being formed by a curved edge of the notch;
the first part comprises a wall extending at least in part about the connection axis, the wall defining a first groove or slot, oriented circumferentially about the connection axis, the ring comprising a pin able to displace in the first groove or slot as the ring rotates relative to the first part; and
the return system comprises a second groove formed by the first part and oriented circumferentially about the connection axis, and a return spring extending along the groove between the first part and the ring.

Another object of the invention is a method of locking/unlocking a first part and a second part of an assembly, the first part and the second part being movable in translation relative to each other according to a connection axis between a locked configuration, in which the first part and the second part are partially fitted into each other and locked to each other, and an unlocked configuration, in which the first part and the second part are spaced apart, the first part comprising one of a rail and a groove, and the second part comprising the other of a rail and a groove, a ring being rotatably mounted on the first part about the connection axis, the ring comprising a wall extending about the connection axis and forming a locking ramp and a housing, the second part defining a radially inner surface relative to the connection axis, said radially inner surface delimiting a housing able to receive at least the wall of the ring in the locked configuration, the second part comprising at least one pin projecting into the housing from the radially inner surface, a return system exerting a return force on the ring toward a rest position of the ring relative to the first part, the method comprising the following steps:
manual axial displacement of the first part and the second part relative to each other from the unlocked configuration to an intermediate configuration,
sliding the rail axially in the groove while the first and second parts move from the unlocked to the locked configuration,
due to said manual displacement, first sliding of the pin on the locking ramp, and automatic angular displacement of the ring in a first direction relative to the first part between the rest position and an intermediate position,
manual axial displacement of the first part and the second part relative to each other from the intermediate configuration to the locked configuration, and
as a result of said manual displacement, automatic angular displacement of the ring relative to the first part in a second direction opposite to the first direction, from the intermediate position to a locked position under the action of the return system, the pin being received in the first housing when the ring is in the locked position, the first housing defining an axial stop blocking the pin axially relative to the first part.

### BRIEF DESCRIPTION OF THE SEVERAL VIEWS OF THE DRAWING(S)

The invention will be better understood on reading the following description, given by way of example only and made with reference to the appended drawings on which:

FIG. 1 is a perspective view of an assembly according to the invention in the unlocked configuration,

FIG. 2 is a perspective view, from another angle, of the first part and of the ring of the assembly shown in FIG. 1,

FIG. 3 is a view of the first part shown in FIGS. 1 and 2, with one body of the ring omitted, and

FIG. 4 is a cross-sectional view of the assembly shown in FIG. 1 according to a radial plane passing through the connection axis of the assembly.

### DETAILED DESCRIPTION OF THE DISCLOSURE

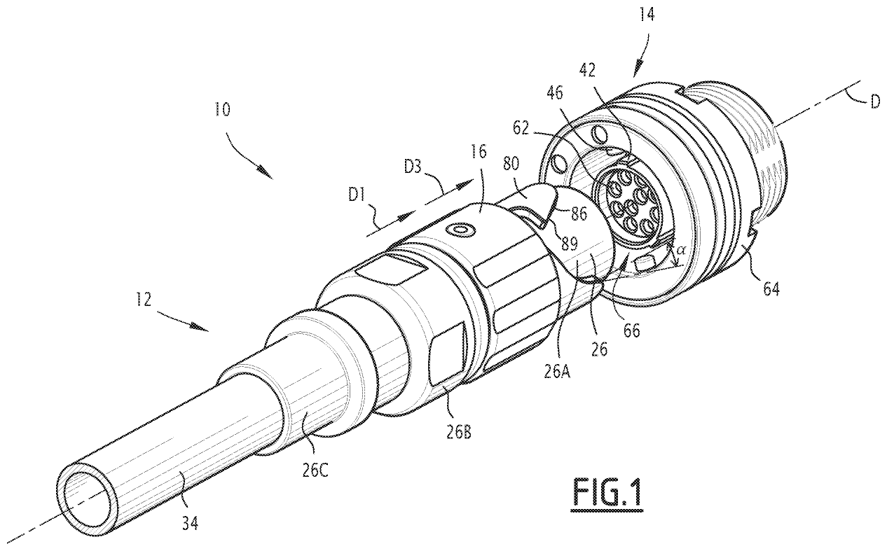

With reference to FIGS. 1 to 4, an assembly 10 according to the invention is described.

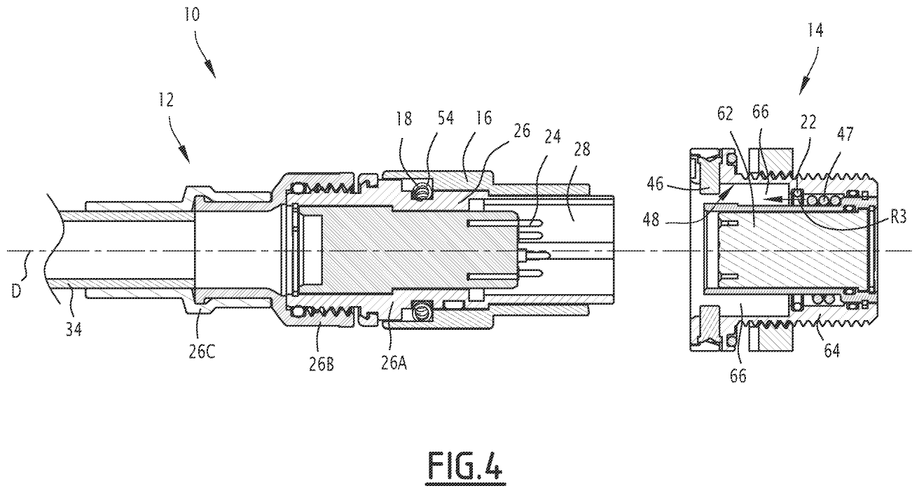

As can be seen from FIGS. 1 and 4, the assembly 10 comprises a first part 12 and a second part 14 which are movable in translation, relative to each other according to a connection axis D, between a locked configuration, in which the first part and the second part are partially fitted into each other and locked to each other, and an unlocked configuration, shown in FIGS. 1 and 4, in which the first part and the second part are spaced apart from each other.

The locked configuration (not shown) is derived from the unlocked configuration by bringing the first part 12 and the second part 14 closer together according to the connection axis D.

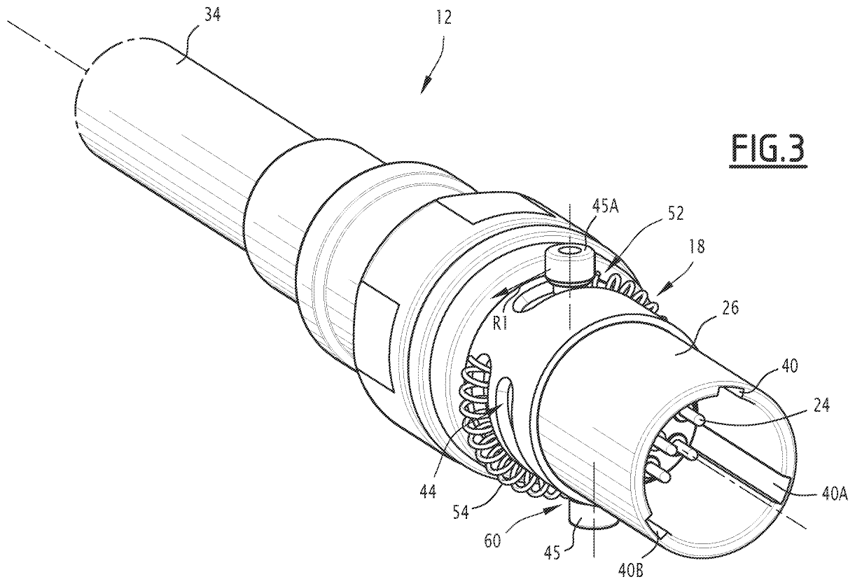

The assembly 10 also comprises a ring 16 rotatably mounted on the first part 12 about the connection axis D, and a return system 18 (visible in FIGS. 3 and 4) able to exert a return force R1 on the ring 16 toward a rest position of the ring relative to first part 12 (shown in FIGS. 1 to 3).

Advantageously, the assembly 10 also comprises an O-ring seal 22 (FIG. 4) fixed to the second part 14 and able to ensure a seal, particularly against liquids and dust, between the first part 12 and the second part 14 in the locked configuration.

The first part 12 comprises a first electrical contact 24, and a first electrical insulation sleeve 26 surrounding the first electrical contact 24 about the connection axis D.

In the example, the first part 12 comprises a plurality of electrical contacts similar to the first electrical contact 24, which is for example of the “needle” type.

According to one alternative, the first part 12 and the second part 14 do not contain any electrical contacts. In this case, the assembly 10 only provides a mechanical connection between the first part 12 and the second part 14. The assembly 10 is then used, for example, to ensure the connection between the oil, water or gas lines such as compressed air.

The first electrical contact 24 is located in a housing 28 (FIG. 4) defined by the first sleeve 26. The first electrical contact 24 extends axially.

By “insulator” is meant here an element the electrical resistivity of which at 300 K is, for example, greater than or equal to 10⁻⁵ Ω·m.

By “conductor” is meant here an element the electrical resistivity of which at 300 K is, for example, less than or equal to 10⁻⁵ Ω·m.

The first electrical contact 24 is able to be electrically connected to an electric cable 34 (FIG. 1) axially inside the first sleeve 26.

Advantageously, the first sleeve 26 is constituted of several parts 26A, 26B and 26C fixed to each other.

The first sleeve 26 forms a groove 40 configured to axially receive a rail 42 (FIG. 1) of the second part 14 when the first part 12 and the second part 14 pass from the unlocked configuration to the locked configuration.

In the example, the first sleeve 26 forms three grooves 40, 40A, 40B, and the second part includes three rails 42, 42A, 42B.

In the example shown, the part 26A of the first sleeve 26 defines a groove 44 (FIG. 3) oriented circumferentially about the connection axis D and in which a pin 45 of the the ring 16 is displaced.

The groove 40 is able to prevent rotation of the first part 12 relative to the second part 14 about the connection axis D when the first part 12 and the second part 14 pass from the unlocked to the locked configuration.

The second part 14 defines a surface 48 (FIG. 4) radially inward relative to the connection axis D, and includes at least one pin 46, the pin projecting from the surface 48 toward the connection axis D.

The second part 14 comprises, for example, a spring 47 located in the housing 66 and able to exert an axial force R3 on the first part 12 in the locked configuration, the axial force being directed from the second part 14 toward the first part 12.

The return system 18 comprises a groove 52 formed by the first part 12 (here more precisely by the wall 26A of the first sleeve 26), and a spring 54 housed in the groove 52.

The groove 52 is oriented circumferentially about the connection axis D.

The spring 54 has a first end 56 fixed to the first part 12, and a second end 58 fixed to the ring 16, for example to a pin 45A (FIG. 3) of the ring 16.

In the example shown, the spring 54 is able to work in compression and push the ring 16 toward its rest position relative to the first part 12, in which the pin 45 abuts against one end 60 of the slot 44.

The second part 14 comprises a second electrical contact 62 able to receive the first electrical contact 24 in the locked configuration, and a second insulating sleeve 64 surrounding the second electrical contact about the connection axis D.

The second electrical contact 62 is located in a housing 66 defined by the second sleeve 64 (FIGS. 1 and 4).

The ring 16 comprises a wall 80 extending about the connection axis D and defining, for example, a notch 84.

The notch 84 opens axially toward the second part 14. The notch 84 is delimited by a curved edge 86.

By “notch”, we mean a radial through cut relative to the connection axis D.

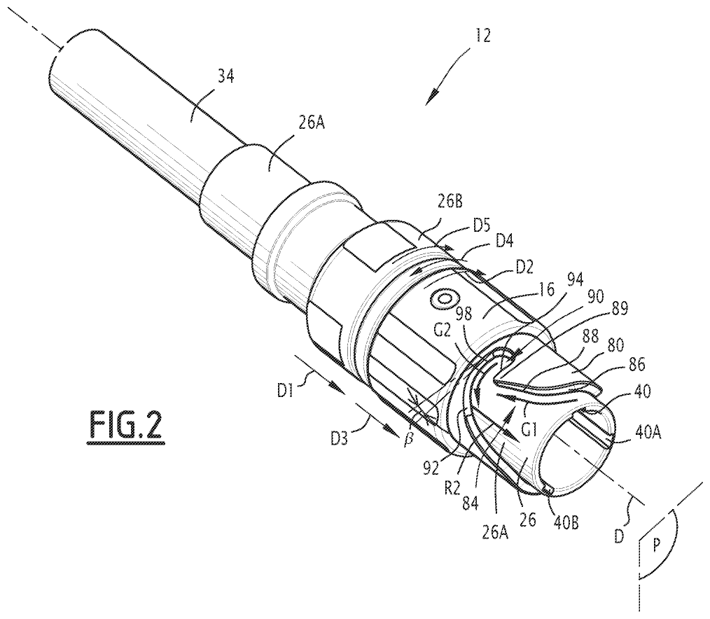

The curved edge 86 forms a locking ramp 88, a housing 90 and, advantageously, a release ramp 92 (FIG. 2).

According to one alternative, not shown, the notch 84 does not exist and the locking ramp 88, the housing 90 and the release ramp 92 are formed by a radial recess (not shown) in the wall 80, the recess defining the edge 86.

The locking ramp 88 is configured so that a manual axial displacement in translation (represented by the arrow D1 in FIGS. 1 and 2) of the first part 12 and the second part 14 relative to each other from the unlocked configuration to an intermediate configuration (not shown) causes a first sliding G1 (FIG. 2) of the pin 46 on the locking ramp 88.

The locking ramp 88 is also configured to cause an automatic angular displacement (shown as arrow D2 in FIG. 2) of the ring 16 in a first direction relative to the first part 12 between the rest position and an intermediate position of the ring.

The intermediate configuration of the assembly 10 is derived from the unlocked configuration shown in FIG. 1 by moving the first part 12 and the second part 14 axially closer together until the pin 46 comes into mechanical contact with the locking ramp 88.

The intermediate position of the ring 16 is derived from the rest position shown in FIG. 2, the pin 46 having slid to a release point 89 and rotated the ring about the connection axis D.

In the example, the locking ramp 88 is at an angle relative to the connection axis D as far as the release point 89.

In the intermediate position, the angular displacement of the ring 16 relative to the first part 12 passes through a local maximum, in the example when the pin 46 slides over the release point 89.

The locking ramp 88 and the housing 90 are configured so that an additional manual axial displacement (represented by an arrow D3 in FIGS. 1 and 2) of the first part 12 and the second part 14 relative to each other from the intermediate configuration to the locked configuration allows an automatic angular displacement (represented by an arrow D4 in FIG. 2) of the ring 16 in a second direction, opposite to the first direction, relative to the first part 12, from the intermediate position to a locked position (not shown) under the action of the return system 18.

In the locked position of the ring 16, the pin 46 is received in the housing 90 which defines an axial stop 94 able to block the pin 46 axially relative to the first part 12 and prevent disengagement of the assembly 10.

In the example shown, the locking position of the ring 16 is substantially identical to the rest position. In other words, the passage of the ring 16 from the rest position shown in FIG. 2 to the intermediate position corresponds to an angular displacement in the direction D2, while the displacement of the ring 16 from the intermediate position to the locked position corresponds to a reverse angular displacement in the direction D4 relative to the first part 12.

The release ramp 92 is configured so that a manual displacement (represented by an arrow D5 in FIG. 2) of the ring 16 in rotation about the connection axis D relative to the first part 12 in the first direction, from the locked position, pulls the pin 46 out of the housing 90, and causes a second sliding G2 of the pin 46 on the release ramp 92; the release ramp 92 reacting axially (force R2 shown in FIG. 2) to move the first part 12 and the second part 14 axially away from each other from the locked configuration.

The release ramp 92 is curved and forms an angle α (FIG. 1) with the connection axis D which reduces with increasing distance away from the housing 90.

The shape and slope of the locking ramp 88 are able to limit the longitudinal connection force along the axis D, and to allow compression of the spring 52 by rotation of the ring 16.

The housing 90 allows good locking of the assembly and good resistance to vibration to be ensured with low connection force.

The shape of the release ramp 92 allows the movement in rotation of the ring 16 about the axis D to be converted into a movement in translation of the first part 12 relative to the second part 14 according to the connection axis D, while maintaining a radial force on the ring 16 equivalent to the compression force of the spring 52 along its longitudinal axis during the disconnection movement.

In the example, the locking ramp 88 and the release ramp 92 diverge relative to each other according to the connection axis D toward the second part 14.

Advantageously, the release ramp 92 comprises a proximal portion 98 relative to the housing 90, the proximal portion 98 forming an angle β of less than 40°, preferably 20°, with any plane P perpendicular to the connection axis D.

In other words, the release ramp 92 has a proximal portion 98 that is very inclined relative to the connection axis D, and therefore only slightly inclined relative to any plane P perpendicular to the connection axis D, so that the reaction R2 of the release ramp 92 on the pin 46 is very strong at the start of the second sliding G2. The release ramp 92 then curves gradually.

For example, the proximal portion 98 of the release ramp 92 is configured so that a 10° rotation of the ring 16 relative to the first part 12 induces an axial displacement of less than 3 mm of the first part relative to the second part.

The ring 16 is, for example, configured so that it can be rotated by at least 20°, preferably at least 30°, relative to the first part 12, in order to perform the disconnection.

Advantageously, the release ramp 92 and the locking ramp 88 overlap axially by more than 6 mm.

The operation of the assembly 10 can be derived from its structure and will now be briefly described.

Initially, the first part 12 and the second part 14 are, for example, in the unlocked configuration shown in FIGS. 1 and 2. The first electrical contact 24 and the second electrical contact 62 are disconnected from each other.

Then, in a connection phase of the assembly 10, the user (not shown) displaces the first part 12 and the second part 14 from the unlocked configuration progressively toward the locked configuration, passing through the intermediate configuration.

The rail 42 slides in the groove 40, guiding the movement in translation of the first part 12 and the second part 14 relative to each other according to the connection axis D, and preventing rotation of first part 12 relative to the second part 14 about the connection axis D.

The pin 46 comes into contact with the locking ramp 88 and performs the first sliding G1 on the locking ramp. The locking ramp 88 reacts on the pin 46 and causes automatic displacement D2 of the ring 16 from its rest position relative to the first part 12 toward its intermediate position. During the first sliding G1, the spring 54 of the return system 18 is compressed.

The passage toward the locked configuration continues with the manual axial displacement D3 of the first part 12 in translation relative to the second part 14. This causes the automatic displacement D4 of the ring 16 in the second direction relative to the first part 12, from the intermediate position to the locked position, under the action of the return system 18.

The pin 46 is then received in the housing 90. The pin 46 locks the first part 12 relative to the second part 14, as the pin 46 abuts against the axial stop 94.

During the first sliding G1, the first contact 24 is inserted into or against the second electrical contact 62 and an electrical contact is established.

In a disconnection phase of the assembly 10, the user performs the manual displacement D5 (FIG. 2) of the ring 16 in rotation relative to the first part 12 about the connection axis D. The first part 12 is blocked in rotation relative to the second part 14 by the rail 42 located in the groove 40. This pulls the pin 46 out of the housing 90 and causes the second sliding G2 of the pin 46 on the release ramp 92.

The release ramp 92 reacts axially on the pin 46 by applying the force R2. This moves the first part 12 away from the second part 14 axially from the locked configuration.

The spring 47 exerts the axial force R3 on the first part 12, assisting the passage from the locked to the unlocked configuration.

Due to the curvature of the release ramp 92, the disengagement force applied to the first part 12 is initially very strong and reduces progressively with the second sliding G2.

At the start of the disengagement movement, the pin 46 travels along the proximal portion 98 of the release ramp 92. The reaction applied to the second part 14 is then very strong. The pin 46 then continues along the rest of the release ramp 92.

In the example, the movement in rotation of the ring 16 eventually continues until the pin 45 abuts against the end 60 of the slot 44. The compression of the spring 52 by the pin 45A is then at its maximum. The user can then release the ring 16. Under the action of the return system 18, the ring 16 rotates toward its rest position (arrow D4) until the pin 46 abuts against the locking ramp 88, on the opposite side of the housing 90 axially, relative to the release point 89.

The user can then perform a manual movement in translation of the first part 12 to continue movement away from the second part 14.

Thanks to the features described above, the connection and disconnection of the first part 12 and the second part 14 is made easier. The locking ramp 88 and the housing 90, together with the pin 46, form an “automatic” bayonet system, as it is not necessary to manually turn the ring 16 relative to the first part 12 to achieve locking. Instead, locking takes place automatically thanks to the first sliding G1 and the reception of the pin 46 in the housing 90.

In addition, unlocking is easy, thanks to the cooperation of the pin 46 with the release ramp 92. This cooperation creates an initially very strong force to disengage the first part 12, advantageously allowing the friction of the seal 22 on the sealing surface 96 to be overcome. The axial force R3 exerted by the spring 47 assists the unlocking.

1. An assembly comprising a first part and a second part movable in translation relative to each other along a connection axis between a locked configuration, in which the first part and the second part are partially fitted into each other and locked to each other, and an unlocked configuration, in which the first part and the second part are spaced apart from each other, wherein:
the first part comprises one of a rail and a groove, and the second part comprises the other one of a rail and a groove, the rail being configured to slide axially in the groove as the first part and the second part move from the unlocked configuration to the locked configuration,
the assembly comprises a ring rotatably mounted on the first part about the connection axis, the ring comprising a wall extending about the connection axis and forming a locking ramp and a housing,
the second part defines a radially inner surface relative to the connection axis, said radially inner surface delimiting a housing able to receive at least the wall of the ring in the locked configuration, the second part including at least one pin projecting into the housing from the radially inner surface,
the first part comprises a return system able to exert a return force on the ring toward a rest position of the ring, and
the locking ramp and the housing are configured so that a manual axial displacement of the first part and the second part relative to each other from the unlocked configuration to an intermediate configuration causes a first sliding of the pin on the locking ramp, and an automatic angular displacement of the ring in a first direction relative to the first part between the rest position and an intermediate position, and so that a manual axial displacement of the first part and the second part relative to each other from the intermediate configuration to the locked configuration allows an automatic angular displacement of the ring relative to the first part in a second direction opposite to the first direction, from the intermediate position to a locked position under the action of the return system, the pin being received in the housing when the ring is in the locked position, the housing defining an axial stop able to block the pin axially relative to the first part.

2. The assembly according to claim 1, wherein:
the first part comprises at least one first electrical contact, and a first electrically insulating sleeve surrounding the first electrical contact about the connection axis, and
the second part comprises at least one second electrical contact, and a second electrically insulating sleeve surrounding the second electrical contact about the connection axis,
the first electrical contact being in electrical contact with the second electrical contact in the locked configuration and spaced apart from the second electrical contact in the unlocked configuration.

3. The assembly according to claim 1, wherein the wall of the ring forms a release ramp adapted so that a manual displacement of the ring in rotation about the connection axis in the first direction relative to the first part from the locked position removes the pin from the first housing and causes a second sliding of the pin on the release ramp, the release ramp exerting an axial force on the pin to move the first part and second part axially away from each other from the locked configuration.

4. The assembly according to claim 3, wherein the release ramp is curved, the release ramp forming an angle with the connection axis which reduces with increasing distance away from the housing.

5. The assembly according to claim 3, wherein the release ramp comprises a proximal portion relative to the housing, the proximal portion forming an angle of less than 40° with any plane perpendicular to the connection axis.

6. The assembly according to claim 5, wherein the angle is less than 20°.

7. The assembly according to claim 1, wherein the second part comprises a spring located in the housing and able to exert an axial force on the first part in the locked configuration, the axial force being directed from the second part toward the first part.

8. The assembly according to claim 1, wherein the wall defines a notch opening axially on the side of the second part, the locking ramp and the housing being formed by a curved edge of the notch.

9. The assembly according to claim 1, wherein the first part comprises a wall extending at least partially about the connection axis, the wall defining a first groove or slot, oriented circumferentially about the connection axis, the ring comprising a pin able to move in the first groove or slot when the ring rotates relative to the first part.

10. The assembly according to claim 1, wherein the return system comprises a second groove formed by the first part and oriented circumferentially about the connection axis, and a return spring extending along the groove between the first part and the ring.

11. A method for locking/unlocking a first part and a second part of an assembly, the first part and the second part being movable in translation relative to each other along a connection axis between a locked configuration, wherein the first part and the second part are partially fitted into each other and locked to each other, and an unlocked configuration, wherein the first part and the second part are spaced apart from each other, the first part comprising one of a rail and a groove, and the second part comprising the other of a rail and a groove, a ring being rotatably mounted on the first part about the connection axis, the ring comprising a wall extending about the connection axis and forming a locking ramp and a housing, the second part defining a radially inner surface relative to the connection axis, said radially inner surface delimiting a housing able to receive at least the wall of the ring in the locked configuration, the second part including at least one pin projecting into the housing from the radially inner surface, a return system exerting a return force on the ring toward a rest position of the ring relative to the first part, the method comprising the following steps:
manual axial displacement of the first part and the second part relative to each other from the unlocked configuration to an intermediate configuration,
sliding the rail axially in the groove while the first part and the second part pass from the unlocked configuration to the locked configuration,
due to said manual displacement, first sliding of the pin on the locking ramp, and automatic angular displacement of the ring in a first direction relative to the first part between the rest position and an intermediate position,
manual axial displacement of the first part and the second part relative to each other from the intermediate configuration to the locked configuration, and
as a result of said manual displacement, automatic angular displacement of the ring relative to the first part in a second direction opposite to the first direction, from the intermediate position to a locked position under the action of the return system, the pin being received in the first housing when the ring is in the locked position, the first housing defining an axial stop blocking the pin axially relative to the first part.
